(19) United States
(12) Patent Application Publication
(10) Pub. No.: US 2025/0366966 A1
(43) Pub. Date: Dec. 4, 2025

(54) OPERATING TABLE FOR SMALL ANIMALS

(71) Applicant: Ohio State Innovation Foundation, Columbus, OH (US)

(72) Inventors: Colleen Cebulla, Columbus, OH (US); Bongsu Kim, Columbus, OH (US)

(21) Appl. No.: 19/222,688

(22) Filed: May 29, 2025

Related U.S. Application Data
(60) Provisional application No. 63/654,538, filed on May 31, 2024.

(51) Int. Cl. A61D 3/00; A61D 7/04

(52) U.S. Cl. CPC A61D 3/00; A61D 7/04

(57) ABSTRACT

An operating table for a small animal may include a housing defining a depression sized to receive a small animal. An operating table for a small animal may include an adjustable nosecone including: a head support liner coupled to the housing and elevated relative to the depression, a delivery port for receiving medicated gas; and a vacuum port configured to couple to a vacuum source to remove excess medicated gas.

### CROSS-REFERENCE TO RELATED APPLICATIONS

This application claims the benefit of U.S. Provisional Patent Application No. 63/654,538 filed on May 31, 2024, the entire contents of which are incorporated herein by reference.

### GOVERNMENT LICENSES RIGHTS

This invention was made with government support under K08 EYO22672 awarded by the National Institutes of Health. The government has certain rights in the invention.

### BACKGROUND

This disclosure relates to operating tables for small animals.

### SUMMARY

In some aspects, the disclosure relates to an operating table of a small animal including: a housing defining a depression sized to receive a small animal; and an adjustable nosecone including: a head support liner coupled to the housing and elevated relative to the depression; a delivery port for receiving medicated gas; and a vacuum port configured to couple to a vacuum source to remove excess medicated gas.

In some aspects, the disclosure relates to an operating table, wherein the housing further defines a head support and a shoulder providing a smooth transition from the depression to the head support.

In some aspects, the disclosure relates to an operating table, wherein the shoulder is generally frustoconically shaped.

In some aspects, the disclosure relates to an operating table, wherein the housing is formed of plastic.

In some aspects, the disclosure relates to an operating table, wherein the depression is cylindrically shaped.

In some aspects, the disclosure relates to an operating table, wherein the adjustable nosecone is formed of clear plastic.

In some aspects, the disclosure relates to an operating table, wherein the delivery port is shaped to receive a gas delivery cone.

In some aspects, the disclosure relates to an operating table, wherein the delivery port defines a shroud shaped to direct the medicated gas to the head of the animal.

In some aspects, the disclosure relates to an operating table, wherein the vacuum port is shaped to receive a vacuum attachment.

In some aspects, the disclosure relates to an operating table, wherein the adjustable nosecone further defines a head cavity spaced between the delivery port and the vacuum port.

In some aspects, the disclosure relates to an operating table, wherein the head cavity is sized to receive a head of the small animal.

In some aspects, the disclosure relates to an operating table, wherein the head cavity is shaped to provide pressure relief for a downward facing eye of the small animal.

In some aspects, the disclosure relates to an operating table, wherein the head support liner is movable relative to the housing.

In some aspects, the disclosure relates to an operating table, wherein the head support liner is shaped to support a neck of the small animal.

In some aspects, the disclosure relates to an operating table, wherein the vacuum port is positioned below the delivery port.

In some aspects, the disclosure relates to an operating table of a small animal including: a housing defining a depression sized to receive a small animal; and a nosecone removably coupled to the housing and including: a delivery cone configured to deliver medicated gas; and a vacuum port spaced apart from the delivery cone by a head cavity, the vacuum port being configured to couple to a vacuum source to remove excess medicated gas.

In some aspects, the disclosure relates to an operating table, wherein the head cavity is sized to receive a head of the small animal.

In some aspects, the disclosure relates to an operating table, wherein the head cavity is shaped to provide pressure relief for a downward facing eye of the small animal.

In some aspects, the disclosure relates to an operating table of a small animal including: a housing defining a depression sized to receive a small animal; and an adjustable nosecone removably coupled to the housing and including: a head support liner coupled to the housing and elevated relative to the depression; a delivery port; a gas delivery cone coupled to the delivery port and configured to supply medicated gas; and a vacuum port spaced apart from the delivery cone by a head cavity, the vacuum port being configured to couple to a vacuum source to remove excess medicated gas.

In some aspects, the disclosure relates to an operating table, wherein the head cavity is sized to receive a head of the small animal and shaped to provide pressure relief for a downward facing eye of the small animal.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1 is a perspective view of a operating table, according to some implementations.

FIG. 2 is another perspective view of the operating table of FIG. 1.

FIG. 3 is another perspective view of the operating table of FIG. 1.

FIG. 4 is a right side view of the operating table of FIG. 1.

FIG. 5 is a top view of the operating table of FIG. 1.

FIG. 6 is a bottom view of the operating table of FIG. 1.

FIG. 7 is a back view of the operating table of FIG. 1.

FIG. 8 is a front view of the operating table of FIG. 1.

### DETAILED DESCRIPTION

Following below are more detailed descriptions of concepts related to, and implementations of, methods, apparatuses, and systems for operating tables for small animals. The figures illustrate exemplary implementations in detail and the present disclosure is not limited to the details or methodology set forth in the description or illustrated in the figures. The terminology used herein is for the purpose of description only and should not be regarded as limiting.

Small animals may require ocular surgery or imaging for research or treatment purposes. A major barrier to ocular surgery in many species, especially birds, is that conventional operating surfaces do not provide adequate support for positioning the head and delivery of gas anesthetic. The operating table for small animals disclosed herein allows optimal head positioning and gas anesthesia delivery during ophthalmic surgery and/or imaging procedures. It is applicable to other types of surgery requiring good head support and lateral positioning and to other animals. The operating table reduces fume exposure to the laboratory staff with a venting mechanism.

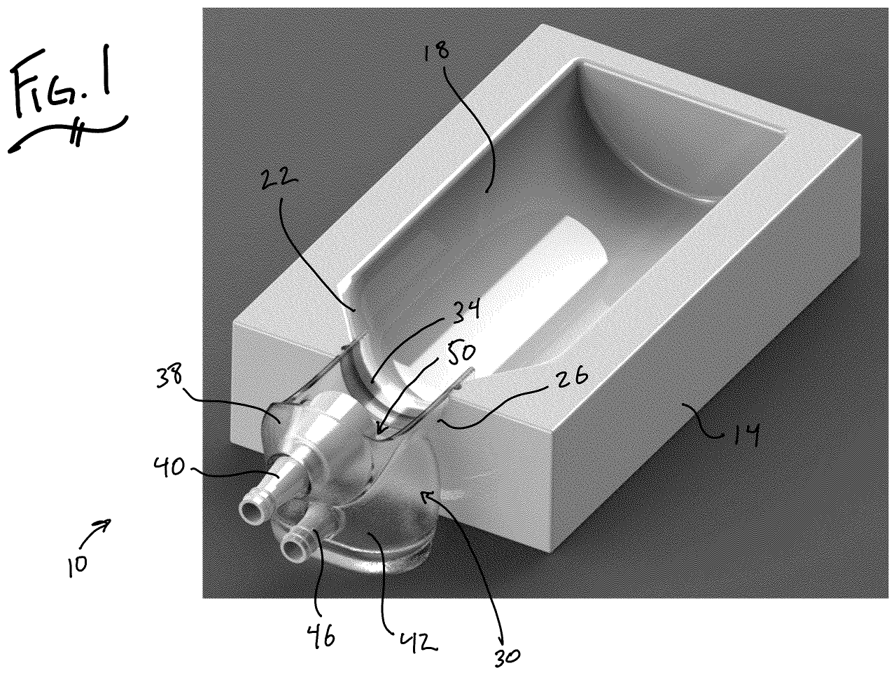

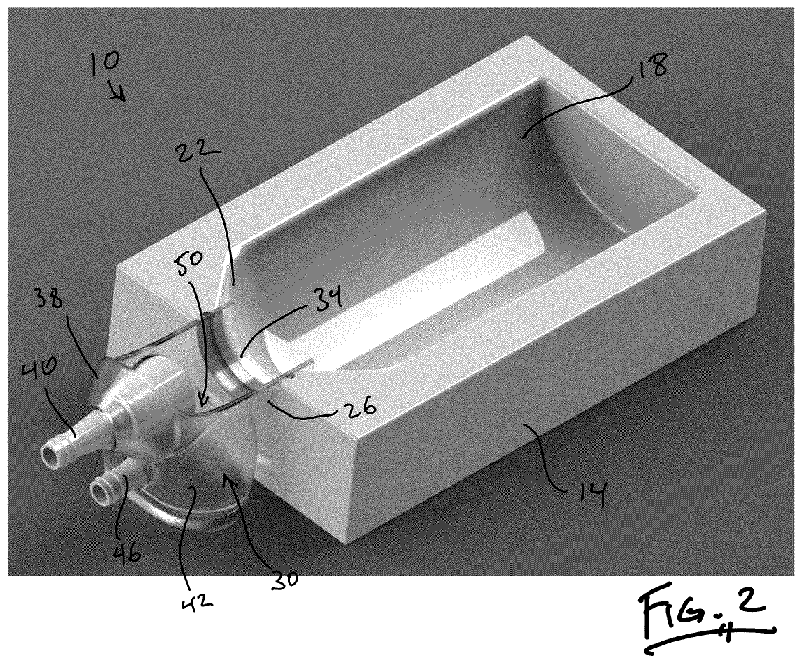

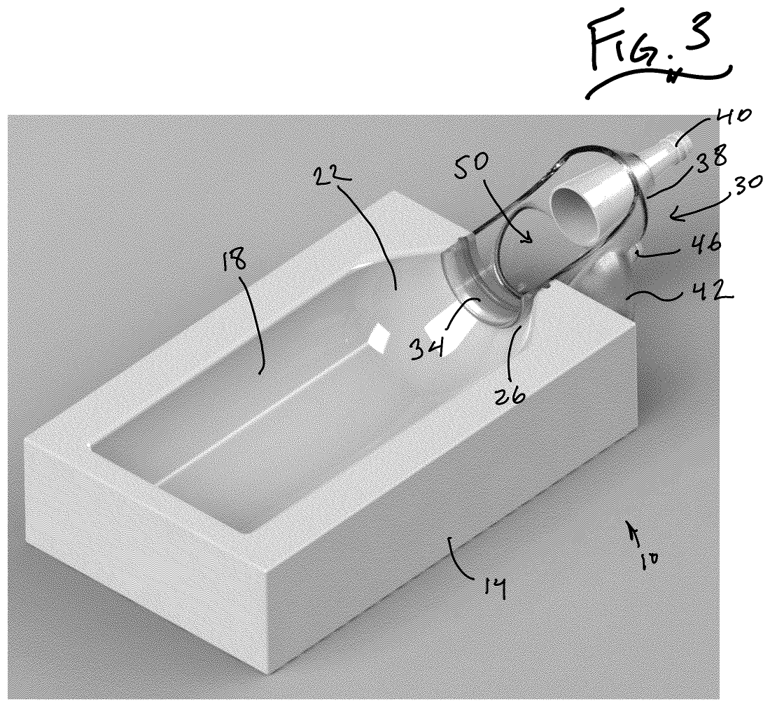

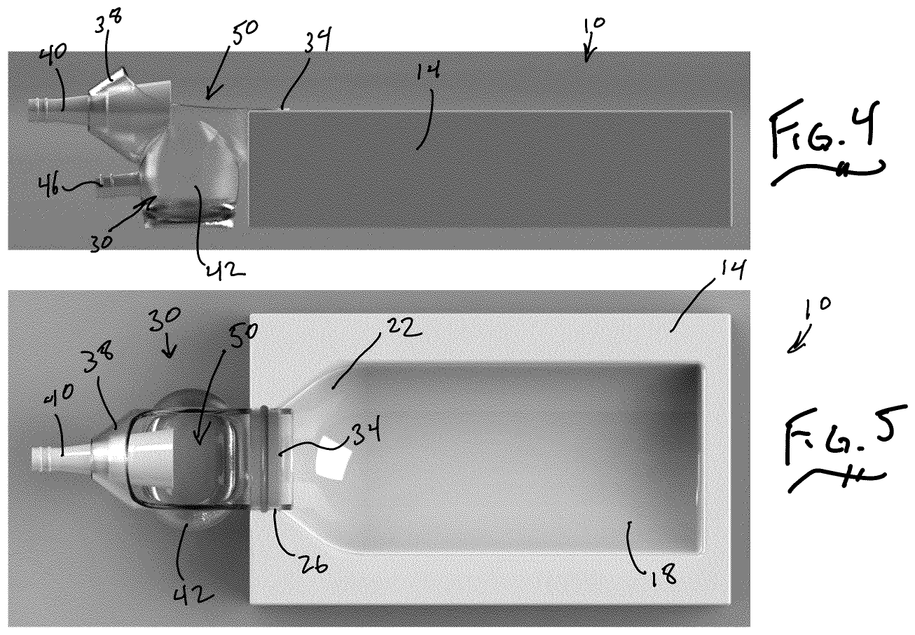

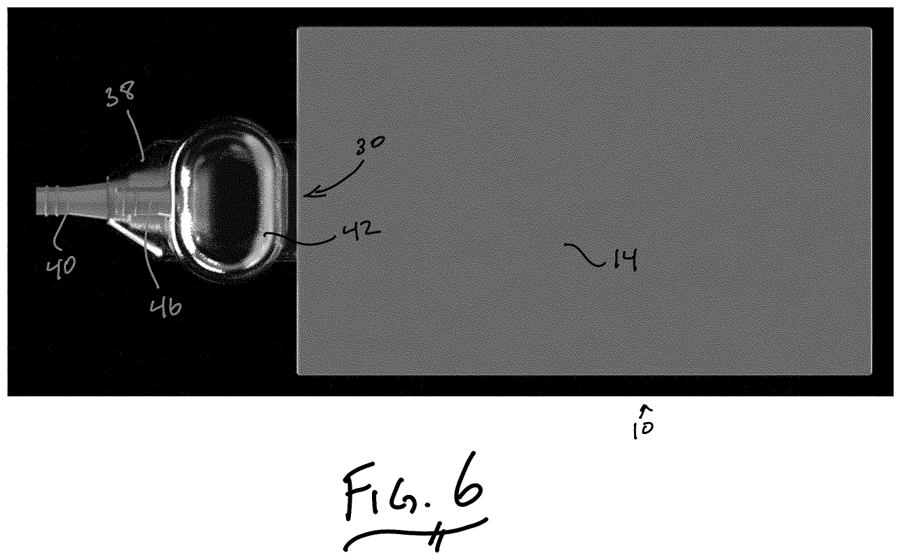

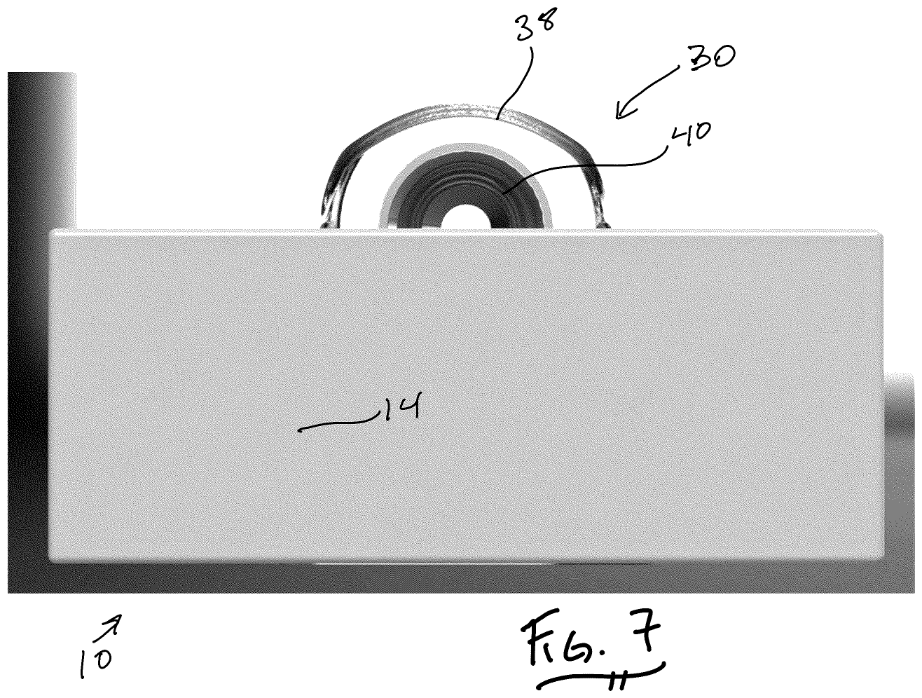

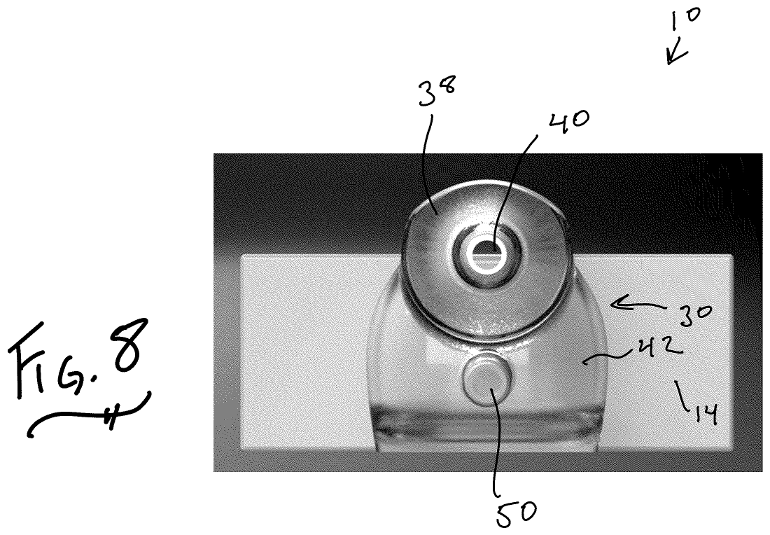

As shown in FIG. 1, an operating table 10 in the form of a small animal laboratory ophthalmic operating table (SALOOT) includes a housing 14 in the form of an easily disinfected plastic bed. An animal holding feature in the form of a depression 18 is formed in the housing 14. In some implementations, the depression 18 is a generally cylindrical depression sized to accommodate small animals (e.g., 2-3 week old chicks). The body of the small animal fits into the depression 18. The housing 14 further defines a shoulder 22 that narrows to a head support 26 that is elevated relative to the depression 18. In some implementations, the shoulder 22 is generally frustoconical in shape and smoothly connects the depression 18 to a semi-circular shaped head support 26. In some implementations, the housing 14 is constructed of a molded plastic.

The head support 26 is shaped to receive an adjustable nosecone 30 that includes a head support liner 34 engaged with and extending over the head support 26 of the housing 14. In some implementations, a height of the head support liner 34 relative to the head support 26 is adjustable to accommodate different animals with different neck and head structures. A delivery port 38 is shaped to receive a gas deliver cone 40 and defines a shroud that directs gas delivered via the cone 40 to the animal. In some implementations, the delivery port 38 and the cone 40 are structured to deliver gas anesthesia such as halothane. Below the delivery port 38 is a vacuum port 42 that is shaped to receive a vacuum attachment 46 to a titratable vacuum source to scavenge excess gas anesthesia from the adjustable nosecone 30 from below and reduce exposure of lab personnel to noxious fumes. A head cavity 50 is formed between the delivery port 38 and the vacuum port 42 and allows space for positioning and accessing the animal's head during use.

The animal may be positioned on its side so that an eye of interest is facing up. The operating table 10 allows head positioning within the head cavity 50 so that a downward facing eye will not have excessive pressure placed on it as it might with conventional positioning. The head position remains stable during imaging and ocular procedures, improving the speed and ease of procedures. The operating table 10 allows good head positioning for species such as birds with longer necks. The depression 18 and head support 26 in concert with the head support liner 34 of the adjustable nosecone 30 keep the head in a good lateral position with the eye parallel to the operating table. In some implementations, the operating table 10 is optimized for ophthalmic surgery or imaging under an operating microscope. Different sizes of the operating table 10 would be available for different species or animal sizes. The operating table 10 may also be used with injectable anesthesia as desired.

The operating table 10 provides better head stability than existing operating tables leading to faster surgery. More stability improves safety and success of procedures. The operating table 10 provides consistent ease of positioning for faster surgery and improved stability. The operating table 10 provides better animal comfort and a lack of pressure on the downward facing eye. The operating table 10 provides better surgeon comfort with scavenging anesthesia.

### Conclusion

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. An operating table of a small animal comprising:
a housing defining a depression sized to receive a small animal; and
an adjustable nosecone including:
a head support liner coupled to the housing and elevated relative to the depression;
a delivery port for receiving medicated gas; and
a vacuum port configured to couple to a vacuum source to remove excess medicated gas.

2. The operating table of claim 1, wherein the housing further defines a head support and a shoulder providing a smooth transition from the depression to the head support.

3. The operating table of claim 2, wherein the shoulder is generally frustoconically shaped.

4. The operating table of claim 1, wherein the housing is formed of plastic.

5. The operating table of claim 1, wherein the depression is cylindrically shaped.

6. The operating table of claim 1, wherein the adjustable nosecone is formed of clear plastic.

7. The operating table of claim 1, wherein the delivery port is shaped to receive a gas delivery cone.

8. The operating table of claim 1, wherein the delivery port defines a shroud shaped to direct the medicated gas to the head of the animal.

9. The operating table of claim 1, wherein the vacuum port is shaped to receive a vacuum attachment.

10. The operating table of claim 1, wherein the adjustable nosecone further defines a head cavity spaced between the delivery port and the vacuum port.

11. The operating table of claim 10, wherein the head cavity is sized to receive a head of the small animal.

12. The operating table of claim 10, wherein the head cavity is shaped to provide pressure relief for a downward facing eye of the small animal.

13. The operating table of claim 1, wherein the head support liner is movable relative to the housing.

14. The operating table of claim 1, wherein the head support liner is shaped to support a neck of the small animal.

15. The operating table of claim 1, wherein the vacuum port is positioned below the delivery port.

16. An operating table of a small animal comprising:
a housing defining a depression sized to receive a small animal; and
a nosecone removably coupled to the housing and including:
a delivery cone configured to deliver medicated gas; and
a vacuum port spaced apart from the delivery cone by a head cavity, the vacuum port being configured to couple to a vacuum source to remove excess medicated gas.

17. The operating table of claim 16, wherein the head cavity is sized to receive a head of the small animal.

18. The operating table of claim 16, wherein the head cavity is shaped to provide pressure relief for a downward facing eye of the small animal.

19. An operating table of a small animal comprising:
a housing defining a depression sized to receive a small animal; and
an adjustable nosecone removably coupled to the housing and including:
a head support liner coupled to the housing and elevated relative to the depression;
a delivery port;
a gas delivery cone coupled to the delivery port and configured to supply medicated gas; and
a vacuum port spaced apart from the delivery cone by a head cavity, the vacuum port being configured to couple to a vacuum source to remove excess medicated gas.

20. The operating table of claim 19, wherein the head cavity is sized to receive a head of the small animal and shaped to provide pressure relief for a downward facing eye of the small animal.
